(19) United States
(12) Patent Application Publication
(10) Pub. No.: US 2013/0198189 A1
(43) Pub. Date: Aug. 1, 2013

(54) MEDIUM STORING BUDGET DETERMINATION SUPPORT PROGRAM, BUDGET DETERMINATION SUPPORT METHOD, AND BUDGET DETERMINATION SUPPORT APPARATUS

(71) Applicant: FUJITSU LIMITED, Kawasaki-shi (JP)

(72) Inventor: Tatsuya ISHIHARA, Yokohama (JP)

(73) Assignee: FUJITSU LIMITED, Kawasaki-shi (JP)

(21) Appl. No.: 13/727,645

(22) Filed: Dec. 27, 2012

(30) Foreign Application Priority Data
Jan. 27, 2012 (JP) 2012-015395

(51) Int. Cl. G06F 17/30

(52) U.S. Cl. CPC G06F 17/30705
USPC 707/737

(57) ABSTRACT

A computer-readable recording medium storing a program for causing a computer to execute a procedure that supports budget determination, the procedure includes: receiving designation of a group that makes up an organization having a hierarchical structure; selecting, between a lower level or a higher level adjacent to a level of the group for which the designation has been received, a level to be referred to when a budget of the group for which the designation has been received is corrected; and correcting the budget relating to the designated group using, among budgets of groups at levels of the organization, a budget of a group belonging to the level to be referred to.

### CROSS-REFERENCE TO RELATED APPLICATION

This application is based upon and claims the benefit of priority of the prior Japanese Patent Application No. 2012-015395, filed on Jan. 27, 2012, the entire contents of which are incorporated herein by reference.

### FIELD

The technique disclosed in the present embodiments relates to a technique for supporting budget determination.

### BACKGROUND

Budgets in an organization are hierarchically determined in units of divisions, departments, sections, and the like. For example, the budget of a division is distributed to departments and sections belonging to the division. Alternatively, the budget for each level is determined by consolidating section budgets to obtain a budget for each department or division that includes the relevant sections.

Thus, when budgets are to be determined, a budget distributed from a higher group to lower groups may possibly not match the budget for the higher group that is obtained by consolidating budgets of the lower groups. In this case, budgets for one or more division, department, or section are adjusted to values according to past achievements.

For example, as a technique for supporting input of values, a method for processing fractions is known in which fractions are processed such that the sum of constituent ratios calculated for data items at a lower level, which are expanded as a breakdown of a data item at a higher level, becomes the same as the constituent ratio of the data item at the higher level. This method is disclosed in Japanese Laid-open Patent Publication No. 11-167600.

### SUMMARY

According to an aspect of the invention, a computer-readable recording medium storing a program for causing a computer to execute a procedure that supports budget determination, the procedure includes: receiving designation of a group that makes up an organization having a hierarchical structure; selecting, between a lower level or a higher level adjacent to a level of the group for which the designation has been received, a level to be referred to when a budget of the group for which the designation has been received is corrected; and correcting the budget relating to the designated group using, among budgets of groups at levels of the organization, a budget of a group belonging to the level to be referred to.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the configuration of a budget management system according to a first embodiment;

FIG. 2 is a block diagram illustrating the functional configuration of a budget management server according to the first embodiment;

FIG. 3 is a diagram illustrating an example of the configuration of authority data;

FIG. 4 is a diagram illustrating an example of the configuration of hierarchy data;

FIG. 5 is a diagram illustrating an example of the configuration of budget data;

FIG. 6 is a diagram illustrating an example of a budget editing screen;

FIG. 7 is a diagram illustrating an example of the budget editing screen;

FIG. 8 is a diagram illustrating an example of the budget editing screen;

FIGS. 9A and 9B are flowcharts illustrating the procedure of a process for supporting budget determination according to the first embodiment; and

FIG. 10 is a diagram illustrating an example of a computer that executes budget determination support programs according to the first embodiment and a second embodiment.

### DESCRIPTION OF EMBODIMENTS

In the above-described method for processing fractions, the sum of the values of data items are determined to be the value of a data item at a higher level. Therefore, in the above-described method for processing fractions, it is difficult to determine the value of a data item at a higher level until the values of data items at a lower level are set. Accordingly, when a budget for a higher group is to be distributed to lower groups, the person who is responsible for inputting budgets inputs the budgets of the lower groups while performing calculations to make the budgets consistent between the higher and lower levels.

The technique disclosed herein has been established in view of the above problem, and aims to improve the convenience of budget determination.

Embodiments of a budget determination support program, a budget determination support apparatus, and a method for supporting budget determination disclosed herein will be described in detail with reference to the drawings. The embodiments do not limit the technique disclosed herein. In addition, the embodiments may be combined with each other insofar as no contradiction arises in the details of processing.

### First Embodiment

### System Configuration

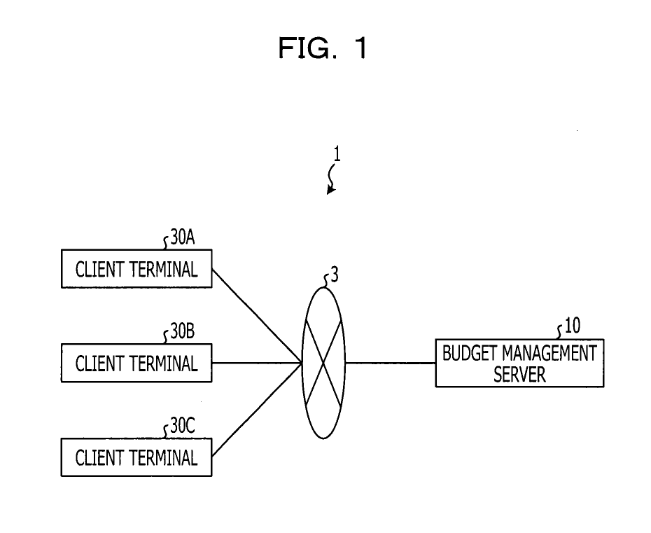

FIG. 1 is a diagram illustrating the configuration of a budget management system according to a first embodiment. A budget management system 1 illustrated in FIG. 1 manages budgets of an organization that has a hierarchical structure. In particular, a budget management server 10 provides a budget determination support service that supports determination of budgets for groups that comprise the organization to client terminals 30A to 30C. Below, an example in which the budget determination support service is provided will be described while envisaging a company that is an example of an organization with a hierarchical structure wherein the company is organized by groups such as divisions, departments, and sections.

As illustrated in FIG. 1, the budget management system 1 includes the budget management server 10 and the client terminals 30A to 30C. Although three client terminals and one budget management server are illustrated in the example illustrated in FIG. 1, the system disclosed herein is not limited to the illustrated configuration. That is, it is sufficient if the budget management system 1 stores at least one budget management server and an arbitrary number of client terminals may be stored. In the following description, when each of the client terminals 30A to 30C is not distinguished from the other client terminals and is referred to by a general term, a “client terminal 30” will be used.

The client terminals 30A to 30C and the budget management server 10 are connected to one another through a network 3 so as to enable communication. Regardless of a wired or wireless nature, as the network 3, a communication network of any kind may be adopted, such as the Internet, a local-area network (LAN), or a virtual private network (VPN).

The client terminal 30 is a terminal apparatus that is provided with the budget determination support service from the budget management server 10. As an aspect of the client terminal 30, not only a fixed terminal such as a personal computer (PC) but also a mobile terminal, such as a mobile telephone, a personal handyphone system (PHS), or a personal digital assistant (PDA), may be adopted. Although a case in which the client terminal 30 functions as a client will be described hereinafter as an example, a client terminal 30 may function as the budget management server 10, instead.

The client terminal 30 is used by an employee who belongs to the company. An example of the employee is a group head, such as a division head who manages a division, a department head who manages a department, or a section head who manages a section. Although a case in which the client terminal 30 is used by a group head is described here as an example, any employee who has been given authority for the determination of budgets may use the client terminal 30.

In an aspect, the client terminal 30 releases the budget determination support service by the budget management server 10 only to employees who have been given authority relating to budget determination from the company. For example, the client terminal 30 receives input of login authentication information, such as an account name and a password. The client terminal 30 then transmits the login authentication information to the budget management server 10 in order to cause the budget management server 10 to perform login authentication for a user of the client terminal 30. At this point, if the login authentication is successful, the budget management server 10 confirms that the user of the client terminal 30 is an employee. In this case, the budget management server 10 permits or prohibits an operation for editing budget data 13c, which will be described later, in accordance with the scope of authority given to the employee.

The budget management server 10 is a server apparatus that manages the budget of a company. The budget management server 10 may be installed as a web server or may be installed in a cloud computing system. In an aspect, when an operation for editing the budget data 13c, which will be described later, has been received, the budget management server 10 determines whether an employee who is using the client terminal 30 has authority to perform the editing operation. Subsequently, if the employee has editing authority, the budget management server 10 permits the operation to edit the budget data 13c, which will be described later. In this case, the budget management server 10 corrects the budget of a group to be edited such that no contradiction arises in consolidation and distribution in relation to budgets with a higher or a lower level as a result of editing the budget of the group.

[Configuration of Budget Management Server 10]

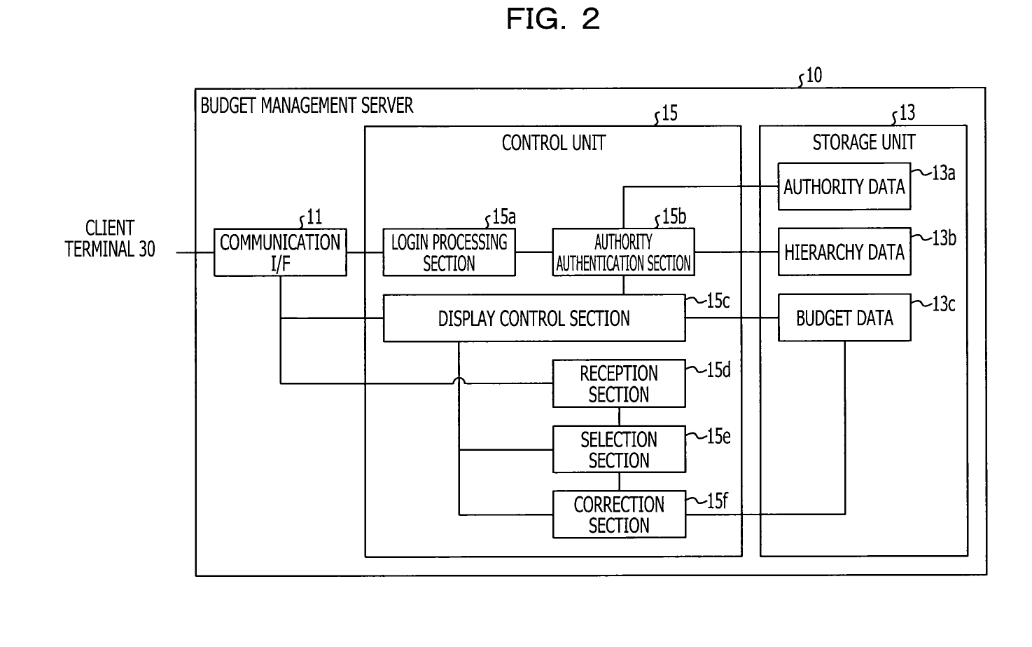

Next, the functional configuration of the budget management server 10 according to the present embodiment will be described. FIG. 2 is a block diagram illustrating the functional configuration of the budget management server 10 according to the first embodiment. As illustrated in FIG. 2, the budget management server 10 includes a communication interface (I/F) 11, a storage unit 13, and a control unit 15. The budget management server 10 may also include various functional units included in a known server apparatus, that is, for example, functional units such as various input devices and audio output devices, in addition to the functional units illustrated in FIG. 2.

The communication I/F 11 is an interface that performs communication control with other apparatuses, that is, for example, the client terminals 30A to 30C. As an aspect of the communication I/F 11, a network interface card such as a LAN card may be adopted. For example, the communication I/F 11 receives authentication information for login from the client terminal 30, and transmits a budget editing screen for editing budget data to the client terminal 30.

The storage unit 13 is a storage device, such as a flash memory or another type of semiconductor memory device, a hard disk, or an optical disk. The storage unit 13 is not limited to one of the storage apparatuses of the above types, and may be a random-access memory (RAM) or a read-only memory (ROM).

The storage unit 13 stores an operating system (OS) executed by the control unit 15 and various programs such as the budget determination support program, which provides the budget determination support service. Furthermore, the storage unit 13 stores authority data 13a, hierarchy data 13b, and the budget data 13c as an example of data used to execute programs executed by the control unit 15.

Among these types of data, the authority data 13a is data in which authority of the employees relating to budget determination is defined. For example, the authority data 13a is referred to by an authority authentication section 15b, which will be described later, in order to identify one of the groups constituting the organization that may be edited by a user who has been confirmed as an employee through login authentication. The authority data 13a is set and registered by an employee who has authority of a manager of the budget determination support program.

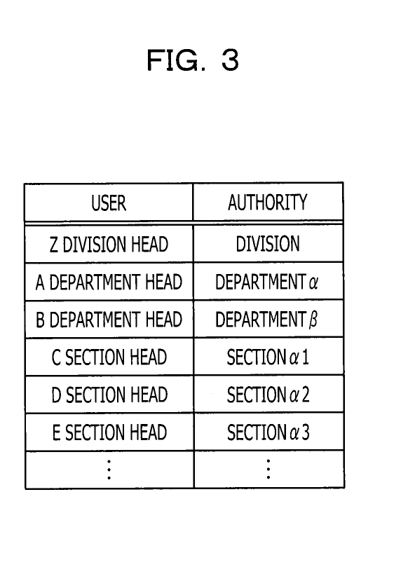

In an aspect, the authority data 13a may consist of data in which a user's account name and group for which budget determination authority has been granted are associated with each other. FIG. 3 is a diagram illustrating an example of the configuration of the authority data 13a. In the example illustrated in FIG. 3, division head Z has authority to determine the budget of the division, department head A has authority to determine the budget of department a, and department head B has authority to determine the budget of department 3. Furthermore, in the example illustrated in FIG. 3, section head C has authority to determine the budget of a section α1, section head D has authority to determine the budget of section α2, and section head E has authority to determine the budget of section α3. The hierarchical relationship between the groups, namely the division, department α, department β, section α1, section α2, and section α3, is defined by the hierarchy data 13b, which will be described later, and the scope of authority changes depending on which level a group for whose budget determination authority has been given is at.

The hierarchy data 13b is data in which the hierarchical relationship between the groups is defined. For example, the hierarchy data 13b is referred to by the authority authentication section 15b, which will be described later, in order to identify the scope of authority relating to the budget determination given to users. The hierarchy data 13b is set and registered by the employee who has the authority of the manager of the budget determination support program.

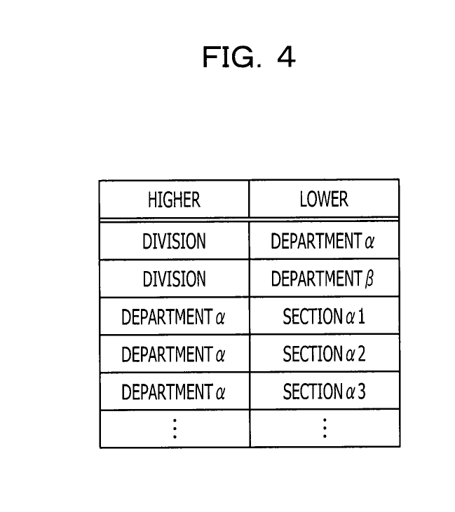

In an aspect, data in which a group at a higher level and a group at a lower level that are adjacent to each other are associated with each other may be adopted as the hierarchy data 13b. FIG. 4 is a diagram illustrating an example of the configuration of the hierarchy data 13b. In the example illustrated in FIG. 4, the division is at the highest level and includes department α and department β as the subgroups thereof, department α is at an intermediate level and includes section α1, section α2, and section α3 as the subgroups thereof, and section α1, section α2, and section α3 are at a lowest level. That is, when the group for which a user has been given authority is the division, it means that the authority of the user covers department α and department β, which are the subgroups of the division, and, moreover, covers section α1, section α2, and section α3, which are subgroups of department a. In addition, when the group for which a user has been given authority is department a, it means that the authority of the user covers section α1, section α2, and section α3, which are subgroups of department a.

Although a case in which authority for budget determination given to a user and the scope thereof are defined by two pieces of data, namely the authority data 13a and the hierarchy data 13b, has been described in FIG. 3 and FIG. 4, these pieces of data may be integrated as a single piece of data. In addition, although groups at three levels, namely division, departments, and sections, have been described in FIG. 3 and FIG. 4 as an example, the number of levels is not limited to 3, and any number of levels equal to or larger than 2 may be adopted, and groups having arbitrary names may be adopted.

The budget data 13c is data in which the budgets of the groups configuring the organization are set. For example, the budget data 13c is referred to by a display control section 15c, which will be described later, in order to generate a budget editing screen to enable a user to edit a budget through the interface of the budget management server 10. In another case, the budget data 13c is updated by a correction section 15f, which will be described later, to data in which a budget has been edited through the budget editing screen. An initial value of a budget in the budget data 13c is set and registered by a user who has authority for the budget determination.

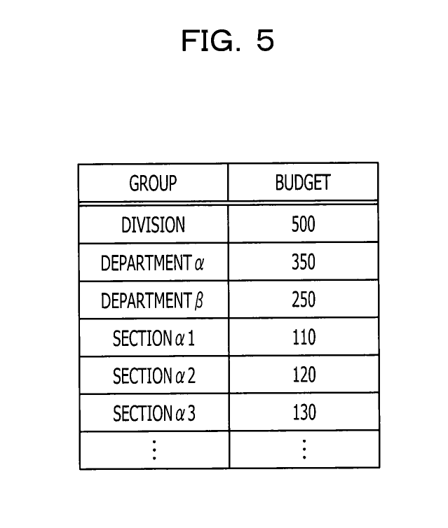

In an aspect, data in which a group and a budget are associated with each other may be adopted as the budget data 13c. FIG. 5 is a diagram illustrating an example of the configuration of the budget data 13c. Although the type of currency or the unit of the amount of money is not indicated in a budget column illustrated in FIG. 5, any type of currency or any unit of the amount of money may be adopted. In the example illustrated in FIG. 5, the budget of the whole division is 500, the budget of department α is 350, the budget of department β is 250, the budget of section α1 is 110, the budget of section α2 is 120, and the budget of section α3 is 130. Thus, until the budgets are determined, consistency of the budgets is not necessarily realized between the groups. Only budgets for one month are illustrated in the example illustrated in FIG. 5, but we assume that the budgets for each group may be set for each month, each half-year, and each year.

The control unit 15 includes an internal memory for storing programs and control data that define various process procedures, and executes various processes using the programs and the control data. As illustrated in FIG. 2, the control unit 15 includes a login processing section 15a, the authority authentication section 15b, the display control section 15c, a reception section 15d, a selection section 15e, and the correction section 15f.

Of the sections, the login processing section 15a is a processing section that executes various processes relating to login. In an aspect, when authentication information regarding login, such as an account name and a password, has been received from the client terminal 30, the login processing section 15a determines whether the account name and the password are correct information that has been registered in advance. In doing so, the login processing section 15a performs login authentication as to whether a user of the client terminal 30 is an employee of the organization. If the user of the client terminal 30 is confirmed to be an employee, that is, if the login authentication is successful, the login processing section 15a outputs the account name of the user to the authority authentication section 15b, which will be described later. If the login authentication fails, the login processing section 15a prompts the user to retry the login authentication and to input an account name and a password again, or prohibits access to the budget data 13c by the client terminal 30 from which login authentication failed.

The authority authentication section 15b is a processing section that confirms the authority of a user. In an aspect, when the login authentication has been successful, the authority authentication section 15b searches the authority data 13a stored in the storage unit 13 for a group associated with the account name of the user who has been confirmed by the login processing section 15a as an employee. In doing so, the authority authentication section 15b identifies the group for whose budget determination the user has authority. Furthermore, the authority authentication section 15b identifies, in the hierarchy data 13b stored in the storage unit 13, a group belonging to a level lower than the level of the group for whose budget determination the user has authority. Accordingly, the authority authentication section 15b identifies the scope covered by the authority of the user. Thereafter, the authority authentication section 15b registers the scope of the authority of the user identified in the above-described manner in the internal memory, which is not illustrated.

The display control section 15c is a processing section that controls the screen display of the client terminal 30. In an aspect, when a login request has been received from the client terminal 30, the display control section 15c causes the client terminal 30 to display a login screen in which an input form for the authentication information regarding login, such as an account name and a password, is provided. At this point, the display control section 15c may automatically input the account name to the input form included in the login screen and prompt the user to input only the password, instead.

In another aspect, when a group for whose budget determination a user has authority has been identified by the authority authentication section 15b, the display control section 15c generates a budget editing screen as described below and outputs the budget editing screen to the client terminal 30. For example, the display control section 15c generates a budget editing screen in which the budgets of the groups defined in the budget data 13c are described using a markup language or the like. At this point, the display control section 15c generates a budget editing screen in which the mode of displaying the budgets differs between a group within the scope of the authority of the user and a group outside the scope of the authority of the user.

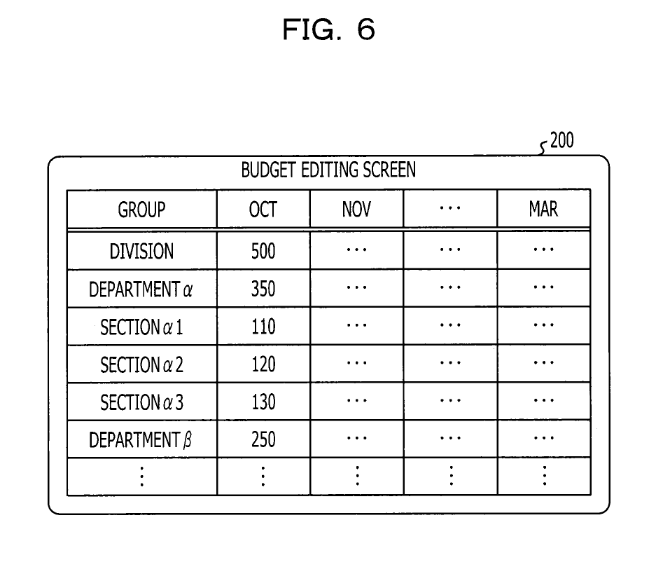

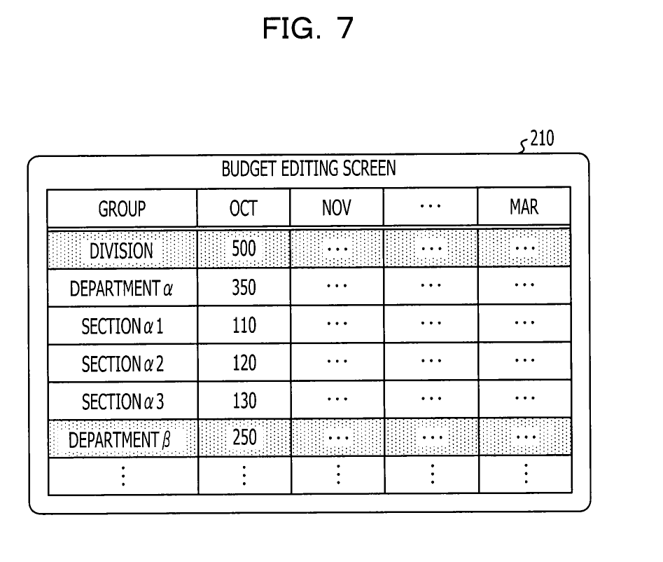

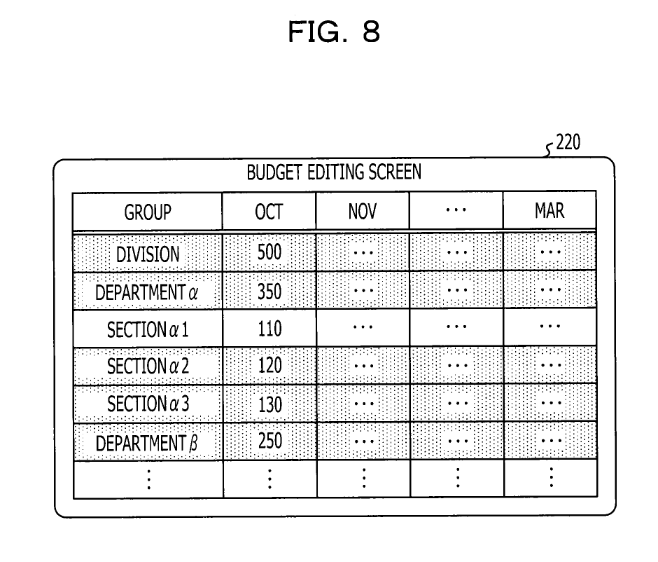

FIGS. 6 to 8 are diagrams illustrating examples of the budget editing screen. In the example illustrated in FIG. 6, a budget editing screen when the account name is division head Z is illustrated, and in the example illustrated in FIG. 7, a budget editing screen when the account name is department head A is illustrated. In the example illustrated in FIG. 8, a budget editing screen when the account name is section head C is illustrated. In addition, in the examples illustrated in FIGS. 6 to 8, a case is assumed in which the budget of a group covered by the authority of a user is displayed without hatching, whereas the budget of a group that is not covered by the authority of the user is displayed with hatching. Although budget editing screens that include the budgets of the groups in a second half-year including the budget data 13c illustrated in FIG. 5 are illustrated in the examples illustrated in FIGS. 6 to 8, an editable period is not limited to a half-year, and a budget in any period may be displayed for each group.

For example, the authority of division head Z for the budget determination covers department α and department β, which are the subgroups of the division, and, moreover, covers section α1, section α2, and section α3, which are the subgroups of department α. Therefore, when the Z division head has logged in, as illustrated in FIG. 6, a budget editing screen 200 in which all the groups are not hatched is displayed on the client terminal 30. By displaying the budget editing screen 200, the Z division head may quickly see that he/she may edit the budgets of all the groups.

In another case, the authority of the A department head for the budget determination does not cover the entirety of the division, but covers section α1, section α2, and section α3, which are subgroups of department a. Therefore, when department head A has logged in, as illustrated in FIG. 7, a budget editing screen 210 in which the budgets of department α, section α1, section α2, and section α3 are not hatched but the budgets of the division and department β are hatched is displayed. By displaying the budget editing screen 210, department head A may quickly see that editable groups for department head A are department α, section α1, section α2, and section α3. Therefore, a situation may be suppressed in which the budgets of the division and department β, which are not covered by the authority of department head A, are edited.

In yet another case, the authority of section head C for the budget determination covers only the section α1, to which section head C belongs. Therefore, when section head C has logged in, as illustrated in FIG. 8, a budget editing screen 220 in which only the budget of section α1 is not hatched and the budgets of the other groups, namely the division, department α, department β, section α2, and section α3, are hatched is displayed. By displaying the budget editing screen 220, section head C may quickly see that the editable group for section head C is only section α1. Therefore, a situation may be suppressed in which the budgets of the groups at the higher levels and the budgets of the groups at the same level, which are not covered by the authority of section head C, are edited.

The reception section 15d is a processing section that receives designation of one of the groups constituting the organization. In one aspect, the reception section 15d receives a designation operation for a group column or a budget column associated with a group on the budget editing screen. For example, as an example of the designation operation, a double click using a mouse, a combination operation with the tab key and the enter key, or the like may be used. The reception section 15d then determines that a group in the column on which the designation operation has been executed on the budget editing screen has been designated as a group whose budget is to be corrected.

Furthermore, the reception section 15d may receive not only the designation of a group to be corrected but also a selection operation as to whether a level to be referred to during the correction is to be a higher level or a lower level. For example, as an example of the selection operation, the designation operation +the up arrow key or the designation operation +the down arrow key may be used. When the designation operation has been performed on the budget editing screen while the up arrow key is being pressed, the reception section 15d determines that a higher level adjacent to a designated level has been selected as a level to be referred to. Conversely, when the designation operation has been performed while the down arrow key is being pressed, the reception section 15d determines that a lower level adjacent to the level on which the designation operation has been performed has been selected as a level to be referred to.

As a result of the selection operation, when the level of the group on which the designation operation has been performed is an intermediate level, it is possible to, at the same time as the designation operation, select whether the correction is to be performed in accordance with a budget distributed from a higher group or in accordance with a budget consolidated from lower groups. The “intermediate level” herein refers to an intermediate level located between a higher level and a lower level. Although a case in which the reception section 15d receives both the selection of a level to be referred to as well as the designation of a group has been described above, the operation for selecting the level to be referred to may be received afterward, but only when the group on which the designation operation has been performed is an intermediate level.

Thereafter, the reception section 15d determines whether the group on which the designation operation has been performed is within the scope of the authority of a user stored in the internal memory, which is not illustrated. At this point, if the group on which the designation operation has been performed is within the scope of the user's authority, the reception section 15d determines that the operation for designating the group is valid, and causes the selection section 15e and the correction section 15f in later stages to execute subsequent processes. Conversely, if the group on which the designation operation has been performed is outside the scope of the user's authority, the reception section 15d does not cause the subsequent processes to be executed. Accordingly, a situation may be suppressed in which the user edits the budget of a group for whose budget determination the user has no authority.

The selection section 15e is a processing section that selects, between a lower level or a higher level adjacent to the level of a group for which designation has been received, a level to be referred to when the budget of the group for which the designation has been received is corrected.

In an aspect, the selection section 15e determines whether the level of the group for which the designation operation has been received is a highest level. At this point, if the level of the group for which the designation operation has been received is the highest level, there is no option but to perform the correction in accordance with a budget consolidated from lower groups. Therefore, the selection section 15e selects a lower level adjacent to the level of the group for which the designation operation has been received as the level to be referred to.

Conversely, if the level of the group for which the designation operation has been received is not the highest level, the selection section 15e further determines whether the level of the group for which the designation operation has been received is a lowest level. At this point, if the level of the group for which the designation operation has been received is the lowest level, there is no option but to perform the correction in accordance with a budget distributed from a higher group. Therefore, the selection section 15e selects a higher level adjacent to the level of the group for which the designation operation has been received as the level to be referred to.

Conversely, if the level of the group for which the designation operation has been received is not the lowest level, the selection section 15e may confirm that the level of the group for which the designation operation has been received is an intermediate level. In this case, it may be determined that both an option to perform the correction in accordance with a budget consolidated from lower groups and an option to perform the correction in accordance with a budget distributed from a higher group remain. Therefore, the selection section 15e determines whether the selection operation has been performed along with the designation operation, that is, whether the level to be referred to has been selected along with the designation of a group.

If the selection operation has not been performed along with the designation operation, the selection section 15e transmits a hierarchy selection screen that includes a dialog box in which a higher level or a lower level adjacent to the level of the group on which the designation operation has been performed may be selected to the client terminal 30. The user is prompted to select the level to be referred to through this hierarchy selection screen.

Thereafter, if the level on which the selection operation has been performed is a lower level, the selection section 15e selects a lower level adjacent to the level of the group for which the designation operation has been received as the level to be referred to. Conversely, if the level on which the selection operation has been performed is a higher level, the selection section 15e selects a higher level adjacent to the level of the group for which the designation operation has been received as the level to be referred to.

Thus, by selecting the level to be referred to during the correction, automatic selection may be realized when the level of the group on which the designation operation has been performed is either the highest level or the lower level, and the selection operation may be performed on a desired level when the level of the group on which the designation operation has been performed is an intermediate level.

The correction section 15f is a processing section that corrects, in the budget data 13c stored in the storage unit 13, a budget relating to the designated group using the budget of a group belonging to the level to be referred to.

In an aspect, if a lower level adjacent to the level of the group on which the designation operation has been performed has been selected as the level to be referred to, the correction section 15f calculates the sum of the values of the budgets of groups belonging to the lower level as a corrected value of the budget relating to the group on which the designation operation has been performed. In another aspect, if a higher level adjacent to the level of the group on which the designation operation has been performed has been selected as the level to be referred to, the correction section 15f executes the following process. That is, the correction section 15f calculates a value obtained by subtracting the sum of the values of the budgets of other groups belonging to the same level as the group on which the designation operation has been performed from the budget of a group at the higher level as the corrected value of the budget relating to the designated group.

Now, a method for correcting a budget will be described using an example of values of the budget data 13c illustrated in FIG. 6. For example, when the section α1 entry under the “group” column or a budget “110” entry for section α1 has been double-clicked on the budget editing screen 200, department a, which is at a higher level, is selected as the level to be referred to since there is no lower level below the level for section α1. In this case, a value “100” obtained by subtracting the sum “250” of the values of the budgets of section α2 and section α3 from the budget “350” of department α as the corrected value of the budget of section α1.

In another example, if the department β entry under the “group” column or a budget “250” entry for department β has been double-clicked on the budget editing screen 200, the division, which is at a higher level, is selected as the level to be referred to since there is no lower level below the level of department β. In this case, a value “150” obtained by subtracting the budget “350” of department a from the budget “500” of the division is used as the corrected value of the budget of department β.

In yet another example, if the department a entry in the “group” column or a budget “350” entry for department a has been double-clicked on the budget editing screen 200, the level on which the selection operation has been performed using either an arrow key or the hierarchy selection screen is selected as the level to be referred to. At this point, if the division, which is at a higher level, has been selected as the level to be referred to, a value “250” obtained by subtracting the budget “250” of department β from the budget “500” of the division is calculated as the corrected value of the budget of the department a. Conversely, if sections α1 to α3, which are at a lower level, have been selected as the level to be referred to, the sum “360” of the values of the budgets for sections α1 to α3 is calculated as the corrected value of the budget for department α. When the budget for section α1 is not “110” but “100” in the budget editing screen 200, consistency is established between the levels of department α and sections α1 to α3, and therefore the division, which is at a higher level, may be automatically selected as the level to be referred to.

In yet another example, if the division entry under the “group” column or the budget “500” entry for the division has been double-clicked on the budget editing screen 200, department α and department β, which are at a lower level, are selected as the level to be referred to since there is no higher level than the level of the division. In this case, the sum “600” of the values of the budgets of department α and department β is selected as the corrected value of the budget for the division.

The control unit 15 may use various integrated circuits and electronic circuits. Alternatively, some of the functional units included in the control unit 15 may be separate integrated circuits or electronic circuits. For example, as an integrated circuit, an application-specific integrated circuit (ASIC) may be used. In addition, as an electronic circuit, a central processing unit (CPU), a micro-processing unit (MPU), or the like may be used.

[Process Flow]

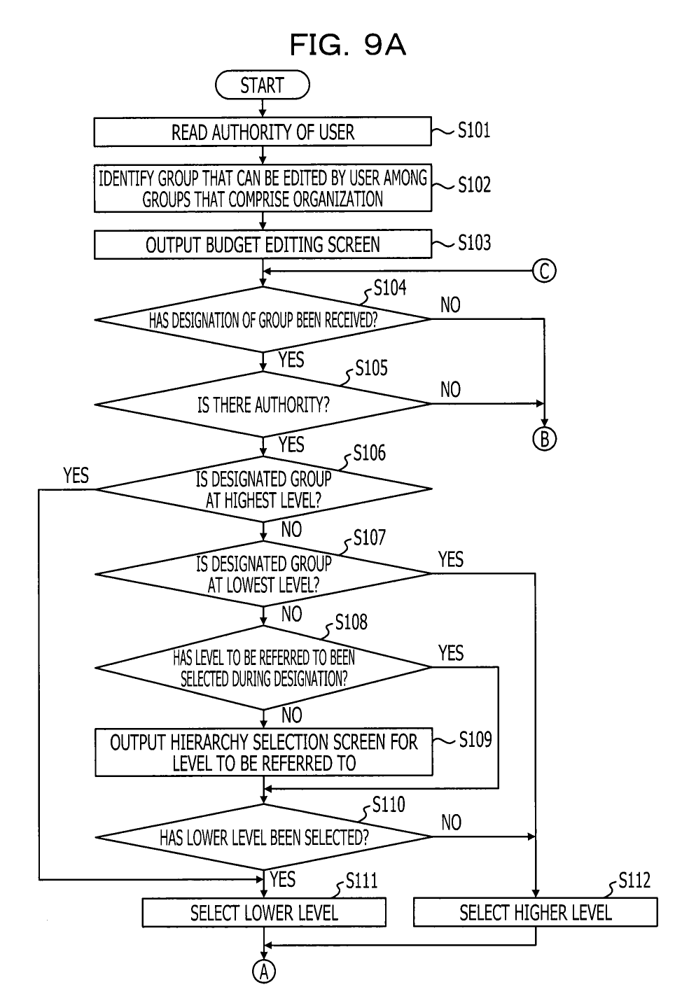

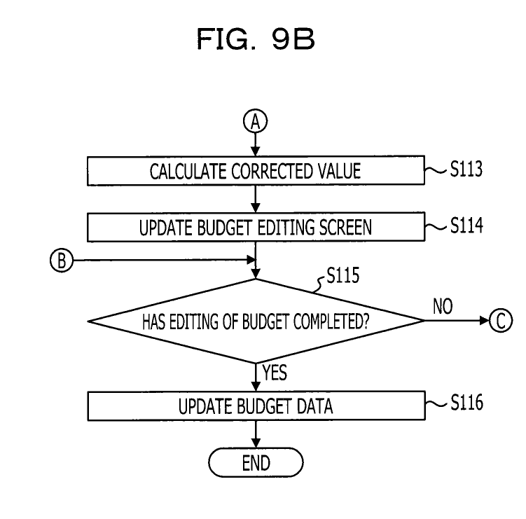

FIGS. 9A and 9B are flowcharts illustrating the procedure of a process to support budget determination according to the first embodiment. The process for supporting budget determination is activated, for example, when login authentication for the client terminal 30 has been successful.

As illustrated in FIG. 9A, the authority authentication section 15b reads the authority data 13a and the hierarchy data 13b stored in the storage unit 13 (step S101). Thereafter, the authority authentication section 15b identifies the scope of the authority of a user based on a group associated with the user's account name and groups belonging to a level lower than the level of the group for whose budget determination the user has authority (step S102).

Next, the display control section 15c generates a budget editing screen in which a mode of displaying budgets is different between a group within the scope of the authority of the user and a group outside the scope of the authority of the user, using budgets of groups defined in the budget data 13c (step S103).

Thereafter, if an operation for designating a group has been performed (YES in step S104), the reception section 15d determines whether the group on which the designation operation has been performed is within the scope of the authority of the user as stored in the internal memory, which is not illustrated (step S105). If an operation for designating a group has not been performed (NO in step S104), the process proceeds to step S115.

At this point, if the group on which the designation operation has been performed is within the scope of the authority of the user (YES in step S105), the selection section 15e determines whether the level of the group for which the designation operation has been received is the highest level (step S106). If the group on which the designation operation has been performed is not within the scope of the authority of the user (NO in step S105), it is determined that the operation for designating the group is invalid, and the process proceeds to step S115.

Next, if the level of the group for which the designation operation has been received is the highest level (YES in step S106), there is no option but to perform correction in accordance with a budget consolidated from lower groups. In this case, the selection section 15e selects a lower level adjacent to the level of the group for which the designation operation has been received as the level to be referred to (step S111).

Conversely, if the level of the group for which the designation operation has been received is not the highest level (NO in step S106), the selection section 15e further determines whether the level of the group for which the designation operation has been received is the lowest level (step S107).

At this point, if the level of the group for which the designation operation has been received is the lowest level (YES in step S107), there is no option but to perform the correction in accordance with a budget distributed from a higher group. In this case, the selection section 15e selects a higher level adjacent to the level of the group for which the designation operation has been received is selected as the level to be referred to (step S112).

Conversely, if the level of the group for which the designation operation has been received is not the lowest level (NO in step S107), it is confirmed that the level of the group for which the designation operation has been received is an intermediate level. In this case, it may be determined that both an option to perform the correction in accordance with budgets added by lower groups and an option to perform the correction in accordance with a budget distributed from a higher group remain. Therefore, the selection section 15e determines whether a selection operation has been performed along with the designation operation, that is, whether a level to be referred to has been selected along with the designation of the group (step S108).

Next, if a selection operation has not been performed along with the designation operation (NO in step S108), the selection section 15e executes the following process. That is, the selection section 15e outputs a hierarchy selection screen that includes a dialog box in which a higher level or a lower level adjacent to the level of the group, on which the designation operation has been performed, may be selected to the client terminal 30 (step S109). If a selection operation has been performed along with the designation operation (YES in step S108), processing in step S109 is omitted, and the process proceeds to processing in step S110.

Next, if a lower level has been selected by the selection operation as the level to be referred to (YES in step S110), the selection section 15e selects the lower level adjacent to the level of the group for which the designation operation has been received as the level to be referred to (step S111).

Conversely, if a higher level has been selected by the selection operation as the level to be referred to (NO in step S110), the selection section 15e selects the higher level adjacent to the level of the group for which the designation operation has been received as the level to be referred to (step S112).

Thereafter, as illustrated in FIG. 9B, the correction section 15f calculates a corrected value of a budget of the group on which the designation operation has been performed, using a budget of a group belonging to the level to be referred to in the budget data 13c stored in the storage unit 13 (step S113). Thereafter, the correction section 15f updates the value of the budget of the group, on which the designation operation has been performed, to the corrected value on the budget editing screen (step S114).

Next, until an operation to end the editing of the budget is performed by the client terminal 30 (NO in step S115), the processing in step S104 to step S114, which has been described above, is repeatedly executed.

Thereafter, if the operation to end the editing of the budget is performed by the client terminal 30 (YES in step S115), the correction section 15f overwrites and updates the budget data 13c after the correction in the storage unit 13 (step S116), and ends the process.

As described above, when designation of a group that constitutes an organization having a hierarchical structure has been received, the budget management server 10 according to the present embodiment selects a level to be referred to during correction and then corrects a budget of the designated group in accordance with a budget of a group belonging to the level to be referred to. That is, when correcting a budget, the budget management server 10 may switch the level to be referred to in accordance with a selection of which of a budget of a higher group or budgets of lower groups to refer to. As a result, the budget management server 10 according to the present embodiment either may perform the correction in accordance with a budget distributed from a higher group or may also perform the correction in accordance with a budget consolidated from lower groups. Therefore, with the budget management server 10 according to the present embodiment, the convenience of budget determination may be improved.

Furthermore, since the budget management server 10 may reflect data for a budget corrected at an intermediate level, a process for recalculating data to be referred to when a table regarding a budget after the correction is to be generated may be omitted. Therefore, the budget management server 10 according to the present embodiment may reduce the amount of calculation compared to an existing method.

### Second Embodiment

Although an embodiment relating to the apparatus disclosed herein has been described above, the present disclosure may be implemented in various different modes other than the above-described embodiment. Therefore, other embodiments included in the present disclosure will be described hereinafter.

[Modification of Correction]

Although a case in which the value of a budget of a group, on which the designation operation has been performed, is updated to a corrected value calculated by the correction section 15f has been described in the first embodiment, the technique disclosed herein is not limited to this. For example, the technique disclosed herein may update the value of the budget of the group on which the designation operation has been performed to a value that is directly input through a numerical keypad of the client terminal 30 or the like.

[Distribution and Integration]

In addition, the components of each apparatus illustrated in the drawings may be physically configured to be different to as illustrated. That is, a specific mode of distribution or integration of each apparatus is not limited to as illustrated in the drawings, and each apparatus may be configured by functionally or physically distributing or integrating the entirety or a part of each apparatus in arbitrary units in accordance with various types of loads, use conditions, and the like. For example, the login processing section 15a, the authority authentication section 15b, the display control section 15c, the reception section 15d, the selection section 15e, or the correction section 15f may be connected through a network as an external apparatus of the budget management server 10, instead. Alternatively, the login processing section 15a, the authority authentication section 15b, the display control section 15c, the reception section 15d, the selection section 15e, and the correction section 15f may be included in different apparatuses, and the functions of the budget management server 10 may be realized by using a network connection and causing these sections to cooperate with one another.

[Budget Determination Support Program]

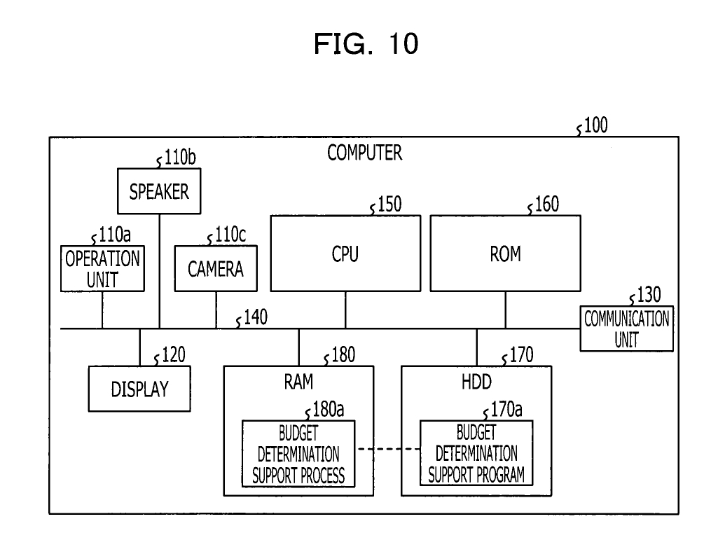

In addition, various processes described in the above embodiment may be realized by executing programs prepared in advance using a computer such as a personal computer or a work station. Therefore, an example of a computer that executes a budget determination support program having the same functions as the above embodiment will be described hereinafter with reference to FIG. 10.

FIG. 10 is a diagram is illustrating an example of a computer that executes budget determination support programs according to the first embodiment and the second embodiment. As illustrated in FIG. 10, a computer 100 includes an operation unit 110a, a speaker 110b, a camera 110c, a display 120, and a communication unit 130. Furthermore, the computer 100 includes a CPU 150, a ROM 160, an HDD 170, and a RAM 180. These components 110 to 180 are interconnected through a bus 140.

As illustrated in FIG. 10, the HDD 170 stores in advance a budget determination support program 170a that realizes the same functions as those of the login processing section 15a, the authority authentication section 15b, the display control section 15c, the reception section 15d, the selection section 15e, and the correction section 15f described in the first embodiment. As with the components illustrated in FIG. 2, namely the login processing section 15a, the authority authentication section 15b, the display control section 15c, the reception section 15d, the selection section 15e, and the correction section 15f, the budget determination support program 170a may be appropriately integrated or divided. That is, with respect to pieces of data stored in the HDD 170, not all the pieces of data are continuously stored in the HDD 170, and only pieces of data used for processing may be stored in the HDD 170.

Next, the CPU 150 reads the budget determination support program 170a from the HDD 170 and deploys the budget determination support program 170a to the RAM 180. In doing so, as illustrated in FIG. 10, the budget determination support program 170a functions as a budget determination support process 180a. The budget determination support process 180a deploys various pieces of data read from the HDD 170 to a region of the RAM 180 that is appropriately assigned for the various pieces of data, and executes various processes based on the deployed pieces of data. The budget determination support process 180a includes the process executed by the login processing section 15a, the authority authentication section 15b, the display control section 15c, the reception section 15d, the selection section 15e, and the correction section 15f illustrated in FIG. 2, that is, for example, the process illustrated in FIGS. 9A and 9B. In addition, with respect to processing sections virtually realized on the CPU 150, not all the processing sections continuously operate on the CPU 150, and only processing sections used for processing may be virtually realized.

The budget determination support program 170a may possibly not stored in the HDD 170 or the ROM 160 from the beginning. For example, a flexible disk to be inserted into the computer 100, that is, a so-called “portable physical medium” such as a floppy disk, a CD-ROM, a DVD, a magneto-optical disk, or an integrated circuit card stores each program. Thereafter, the computer 100 may obtain each program from this portable physical medium and execute each program, instead. Alternatively, another computer, a server apparatus, or the like connected to the computer 100 through a public line, the Internet, a LAN, a WAN, or the like may store each program, and the computer 100 may obtain each program from the other computer, the server apparatus, or the like and execute each program.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable recording medium storing a program for causing a computer to execute a procedure that supports budget determination, the procedure comprising:
receiving designation of a group that makes up an organization having a hierarchical structure;
selecting, between a lower level or a higher level adjacent to a level of the group for which the designation has been received, a level to be referred to when a budget of the group for which the designation has been received is corrected; and
correcting the budget relating to the designated group using, among budgets of groups at levels of the organization, a budget of a group belonging to the level to be referred to.

2. The computer-readable recording medium according to claim 1, the procedure further comprising:
receiving, between levels adjacent to the level of the group for which the designation has been received, selection of a higher level or a lower level,
wherein the selecting selects the lower level adjacent to the level of the group, when the level of the group for which the designation has been received is a highest level, selects the higher level adjacent to the level of the group, when the level of the group is a lowest level, and selects a level for which selection has been received, when the level of the group is an intermediate level.

3. The computer-readable recording medium according to claim 2, the procedure further comprising:
judging whether the level of the group for which the designation has been received is, among pieces of authority stored in an authority storage unit that stores authority of each user while associating the authority of each user with each user, within a scope of authority associated with a user who has performed the designation,
wherein the receiving of the designation of the group determines that the designation of the group is valid, when the level of the group for which the designation has been received is within the scope of the authority of the user who has performed the designation.

4. The computer-readable recording medium according to claim 3, the procedure further comprising:
changing a mode of displaying a budget between a group within the scope of the authority of the user who has performed the designation and a group outside the scope of the authority.

5. The computer-readable recording medium according to claim 1, wherein the correcting, when the lower level adjacent to the level of the group for which the designation has been received is selected, calculates a corrected value of the budget relating to the designated group from budgets of groups belonging to the lower level, and when the higher level adjacent to the level of the group for which the designation has been received is selected, calculates the corrected value of the budget relating to the designated group from a budget of a group at the higher level and budgets of other groups belonging to the same level as the group for which the designation has been received.

6. A budget determination support method to be executed by a computer, the method comprising:
receiving designation of a group that makes up an organization having a hierarchical structure;
selecting, between a lower level or a higher level adjacent to a level of the group for which the designation has been received, a level to be referred to when a budget of the group for which the designation has been received is corrected; and
correcting the budget relating to the designated group using, among budgets of groups at levels of the organization, a budget of a group belonging to the level to be referred to.

7. The budget determination support method according to claim 6, further comprising:
receiving, between levels adjacent to the level of the group for which the designation has been received, selection of a higher level or a lower level,
wherein the selecting selects the lower level adjacent to the level of the group, when the level of the group for which the designation has been received is a highest level, selects the higher level adjacent to the level of the group, when the level of the group is a lowest level, and selects a level for which selection has been received, when the level of the group is an intermediate level.

8. The budget determination support method according to claim 7, further comprising:
judging whether the level of the group for which the designation has been received is, among pieces of authority stored in an authority storage unit that stores authority of each user while associating the authority of each user with each user, within a scope of authority associated with a user who has performed the designation,
wherein the receiving of the designation of the group determines that the designation of the group is valid, when the level of the group for which the designation has been received is within the scope of the authority of the user who has performed the designation.

9. The budget determination support method according to claim 8, further comprising:
changing a mode of displaying a budget between a group within the scope of the authority of the user who has performed the designation and a group outside the scope of the authority.

10. The budget determination support method according to claim 6, wherein the correcting, when the lower level adjacent to the level of the group for which the designation has been received is selected, calculates a corrected value of the budget relating to the designated group from budgets of groups belonging to the lower level, and when the higher level adjacent to the level of the group for which the designation has been received is selected, calculates the corrected value of the budget relating to the designated group from a budget of a group at the higher level and budgets of other groups belonging to the same level as the group for which the designation has been received.

11. A budget determination support apparatus, comprising:
a memory configured to store, for groups at levels of an organization having a hierarchical structure, budgets of the groups while associating the budgets of the groups with the groups at the levels; and
a processor configured to execute a procedure, the procedure comprising:
receiving designation of a group that makes up the organization,
selecting, between a lower level or a higher level adjacent to a level of the group for which the designation has been received, a level to be referred to when a budget of the group for which the designation has been received is corrected, and
correcting the budget relating to the designated group using, among the budgets stored in the memory, a budget of a group belonging to the level to be referred to.

12. The budget determination support apparatus according to claim 11, the procedure further comprising:
receiving, between levels adjacent to the level of the group for which the designation has been received, selection of a higher level or a lower level,
wherein the selecting selects the lower level adjacent to the level of the group, when the level of the group for which the designation has been received is a highest level, selects the higher level adjacent to the level of the group, when the level of the group is a lowest level, and selects a level for which selection has been received, when the level of the group is an intermediate level.

13. The budget determination support apparatus according to claim 12, the procedure further comprising:
judging whether the level of the group for which the designation has been received is, among pieces of authority stored in an authority storage unit that stores authority of each user while associating the authority of each user with each user, within a scope of authority associated with a user who has performed the designation,
wherein the receiving of the designation of the group determines that the designation of the group is valid, when the level of the group for which the designation has been received is within the scope of the authority of the user who has performed the designation.

14. The budget determination support apparatus according to claim 13, the procedure further comprising:
changing a mode of displaying a budget between a group within the scope of the authority of the user who has performed the designation and a group outside the scope of the authority.

15. The budget determination support apparatus according to claim 11, wherein the correcting, when the lower level adjacent to the level of the group for which the designation has been received is selected, calculates a corrected value of the budget relating to the designated group from budgets of groups belonging to the lower level, and when the higher level adjacent to the level of the group for which the designation has been received is selected, calculates the corrected value of the budget relating to the designated group from a budget of a group at the higher level and budgets of other groups belonging to the same level as the group for which the designation has been received.
